(19) United States
(12) Patent Application Publication
(10) Pub. No.: US 2006/0084737 A1
(43) Pub. Date: Apr. 20, 2006

(54) Polyester resin binder

(75) Inventors: Gregory Briner, New Albany, IN (US); Vinay Malhotra, Louisville, KY (US); Philippe Espiard, Gouvieux (FR); Pete Herault, North Wales, PA (US); Sanford Moyer, Harleysville, PA (US); Kevin J. Gallagher, Plymouth Mtg, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: CERTAINTEED CORPORATION, Valley Forge, PA (US)

(21) Appl. No.: 10/964,686

(22) Filed: Oct. 15, 2004

(51) Int. Cl. C08K 5/05

(52) U.S. Cl. 524/387

(57) ABSTRACT

The present invention relates to a composition of at least one cation of an element selected from Group IIA elements, transition metals, Group IIB elements, Group IIIA elements, Si, Ge, Sn, Pb, As, Sb, Bi, Te, and Po and at least one polyester resin, which can be used as a low VOC binder for the manufacture of fibrous insulation.

### BACKGROUND OF THE INVENTION

1. Field of the Invention

The present invention relates to a composition of at least one cation of an element selected from Group IIA elements, transition metals, Group IIB elements, Group IIIA elements, Si, Ge, Sn, Pb, As, Sb, Bi, Te, and Po and at least one polyester resin, which can be used as a low volatile organic compound (VOC) binder for the manufacture of fibrous insulation.

2. Discussion of the Background

Fibrous glass insulation products generally include glass fibers bonded together in a porous structure such as a mat, batt or blanket using a binder of a cured thermoset polymeric material. The glass fibers can be made using various techniques known in the art involving extrusion and/or drawing of molten glass. Porous structures can be formed by coating a binder solution on glass fibers, blowing and depositing the coated glass fibers onto a moving conveyor belt, and heating the deposited coated fibers to cure the binder. The cured binder captures and holds together the fibers in the porous structure to form the fibrous insulation product.

Phenol-formaldehyde binders are currently used throughout the fibrous glass insulation industry. These binders have a desirable low viscosity in the uncured state, yet form a rigid thermoset polymer for joining glass fibers when cured. Such binders allow porous fibrous glass insulation products that are compressed during packaging to expand to pre-compression dimensions upon installation.

However, phenol-formaldehyde binders are known to release formaldehyde, phenol and other volatile organic compounds (VOCs) to the environment when cured.

A number of attempts have been made to produce binders that release smaller amounts of undesirable VOCs.

U.S. Pat. No. 5,318,990 discloses a fibrous glass binder comprising a polycarboxy polymer, a monomeric trihydric alcohol and a catalyst comprising an alkali metal salt of a phosphorous-containing organic acid.

U.S. Pat. No. 5,340,868 discloses a fibrous glass binder comprising a polycarboxy polymer, a β-hydroxyalkylamide, and an at least trifunctional monomeric carboxylic acid.

U.S. Pat. No. 5,661,213 discloses a formaldehyde-free curable aqueous composition containing a polyacid, a “polyol” described as containing at least two hydroxyl groups, and a phosphorus-containing accelerator. The composition is described as being useful as a binder for heat resistant nonwovens such as nonwovens composed of fiberglass.

U.S. Pat. No. 6,080,807 discloses an aqueous emulsion of a substantially solvent free polyester resin and ethylene oxide/propylene surfactant. The emulsion is described as being useful as a film-forming agent in sizing compositions used in the manufacture of glass fibers for the reinforcement of polymeric articles.

U.S. Pat. No. 6,331,350 B1 discloses a fiberglass binder that contains a polycarboxy polymer and a “polyol”, described as containing at least two hydroxyl groups, with a pH no greater than 3.5. The binder describes in U.S. Pat. No. 6,331,350 can include a catalyst that is an alkali metal salt of a phosphorus-containing organic acid.

European Patent No. 0 990 727 A1 discloses a fiberglass binder comprising a polycarboxy polymer and a “polyol”, described as containing at least two hydroxyl groups.

European Patent No. 0 990 728 A1 discloses a low molecular weight fiberglass binder comprising a polycarboxy polymer and a “polyol”, described as containing at least two hydroxyl groups. The binder described in European Patent No. 0 990 728 A1 can include a catalyst that is alkali metal salt of a phosphorus-containing organic acid.

There continues to be a need for new fibrous glass binders that can be cured with minimal release of undesirable VOCs and that, when cured, exhibit mechanical properties similar to those of conventional cured phenol-formaldehyde binders.

### SUMMARY OF THE INVENTION

The present invention provides a fibrous glass binder containing at least one polyester resin and at least one cation of an element selected from Group IIA elements, transition metals, Group IIIB elements, Group IIIA elements, Si, Ge, Sn, Pb, As, Sb, Bi, Te, and Po. The polyester resin includes polyester molecules each containing two or more carboxyl groups. The binder cures upon heating by bonding individual cations directly to two or more carboxylate anions formed from different polyester molecules. The individual cations and the carboxylate anions can form a coordination complex. The polyester molecules can be formed by esterfication of diols with carboxylic acids containing two or more carboxyl groups or with anhydrides of carboxylic acids containing two or more carboxyl groups. The binder can be used to make porous fibrous insulation products, for example, such as insulation products based on mineral and/or rock wool with mechanical properties comparable to those of insulation products made using conventional phenol-formaldehyde binders without generating large amounts of undesirable VOCs.

### BRIEF DESCRIPTION OF THE DRAWINGS

FIG. 1A shows an infrared spectrum of a dry film of the cured polyester binder prior to addition of ZnO.

FIG. 1B shows an infrared spectrum of a dry film of the cured polyester binder of FIG. 1A after addition of ZnO.

### DETAILED DESCRIPTION OF PREFERRED EMBODIMENTS

The present invention provides a low VOC emission binder particularly suited for binding together fibrous glass in porous insulation products. The binder contains a polyester resin and at least one cation of an element selected from Group IIA elements, transition metals, Group IIB elements, Group IIIA elements, Si, Ge, Sn, Pb, As, Sb, Bi, Te, and Po. Upon heating, the cations cross-link the binder by bonding directly to two or more carboxylate anions formed from different polyester molecules. The cross-linking can be in the form of coordination complexes formed by the cations and carboxylate anions.

The term “polyester” as used herein refers to a polymer that can be produced by the condensation reaction of at least one carboxylic acid and at least one alcohol where the backbone of the polymer includes ester linkages.

The polyester resin includes polyester molecules each containing at least two carboxyl groups, for example, three, four or more carboxyl groups. The polyester molecules can be produced in an esterification reaction by heating a mixture comprising one or more diols and one or more of carboxylic acids containing at least two carboxyl groups and anhydrides of carboxylic acids containing at least two carboxyl groups. The esterification reaction can be carried out at temperatures from 50 to 200° C., and from 80 to 140° C., including 60, 70, 90, 100, 110, 120, 130, 150, 160, 170, 180, 190° C. and all values and subranges there between. Mineral acids, such as sulfuric acid, hydrochloric acid and nitric acid, can be used to catalyze the esterification reaction. Preferably, the polyester is produced by the esterification of a dicarboxylic acid or an anhydride derivative thereof, and a diol. More preferably, the polyester is produced from maleic anhydride and a propylene glycol. To ensure that the polyester molecules produced by the esterification reaction have carboxyl groups available to cross-link with the cations, in the esterification reaction the ratio of the concentration of carboxyl groups to the concentration of hydroxyl groups, (i.e., [COOH]/[OH]), is greater than 0.5, preferably greater than 0.75, but less than 2, including 0.6, 0.7, 0.8, 0.9. 1.0. 1.1, 1.2, 1.3, 1.4, 1.5, 1.6, 1.7, 1.8, 1.9 and all values and subranges there between. The weight average molecular weight of the polyester can be from 200 to 5000, preferably from 200 to 1000 g/mole, including 300, 400, 500, 600, 700, 800, 900, 1100, 1500, 2000, 2500, 3000, 3500, 4000, 4500, and all values and subranges there between. The polyester can include oligomers containing only a few monomer units (e.g., dimer, trimer, tetramer) and/or polymers containing more than a few monomer units (e.g., 5, 6, 7, 8, 9 or 10 monomer units). As polyester resins are reacted, they typically lose their water solubility when polar hydroxyl and carboxyl groups condense to form a more non-polar resin. These types of solution polymers typically have low dilutability in water and require a solvent to be less viscous. This resin, however, is infinitely dilutable in water because some of the carboxyl groups and hydroxyl groups are not reacted. The residual free propylene glycol serves as a co-solvent with the water and as a reactant for further condensation during the curing of the final insulation binder.

Suitable carboxylic acids containing at least two carboxyl groups include carboxylic acids given by the formula HOOC—R—COOH, where R is an alkyl, alkenyl, alkynyl or aryl group containing 1 to 10 carbon atoms. Preferably R contains from 1 to 3 carbon atoms. R can be substituted or unsubstituted. In particular, R can be substituted with one or more additional carboxyl groups, resulting in a carboxylic acid with three or more carboxyl groups.

Suitable anhydrides of carboxylic acids containing at least two carboxyl groups include anhydrides of the formula (RC═O)₂O where R is an alkyl, alkenyl, alkynyl or aryl group containing 1 to 10 carbon atoms, including 2, 3, 4, 5, 6, 7, 8, 9 and all ranges there between. Preferably R contains from 1 to 3 carbon atoms. R can be substituted or unsubstituted. Preferably the anhydride is maleic anhydride.

Suitable diols include aliphatic and aromatic molecules substituted with two hydroxyl groups. The diols can be saturated or unsaturated. Because 1,2 propanediol is less volatile and toxic than ethylene glycol, 1,2 propanediol (propylene glycol) is the preferred diol.

When a polyol, containing at least three hydroxyl groups, is present in the esterification mixture, its role is to cross-link polyester molecules in the polyester resin. Thus, in embodiments of the present invention, the cured binder can contain polyester molecules cross-linked by both cations and polyol residues. Preferably, the polyol contains four or more hydroxyl groups. Preferably, the polyol is pentaerythritol.

In addition to the polyester resin, the binder of the present invention contains cations for cross-linking the polyester resin to cure the binder. Suitable cations are of elements selected from Group IIA elements, transition metals, Group IIB elements, Group IIIA elements, Si, Ge, Sn, Pb, As, Sb, Bi, Te, and Po. Group IIIA elements include Be, Mg, Ca, Sr, Ba and Ra. Transition metals include Sc, Ti, V, Cr, Mn, Fe, Co, Ni, Cu, Y, Zr, Nb, Mo, Tc, Ru, Rh, Pd, Ag, La, Hf, Ta, W, Re, Os, Ir, Pt, and Au. Group IIB elements include Zn, Cd, and Hg. Group IIIA elements include B, Al, Ga, In and Tl. Preferably the cations are divalent. More preferably, the cations include Zn²⁺. Due to environmental and human health concerns, the use of cations of certain elements, such as Ra, Cr, Cd, Hg, Tl, Pb, As and Po, is not preferred. The cations can be introduced into the binder by reacting a compound containing one or more of the cations with the polyester resin. For example, a powder of a compound containing a cation can be added to the polyester resin. Alternatively, a compound containing a cation can be dissolved in a solvent, and the resulting solution containing the cation can then be combined with the polyester resin. Preferably the solvent is water. Volatile solvents are not preferred as solvents, because they can be released to the environment as pollutants when the binder is cured. The weight ratio of a compound containing a cation (e.g., ZnO) to the polyester resin can be from 0.02 to 0.10, including 0.03, 0.04, 0.05, 0.06, 0.07, 0.08, 0.09, and all values and subranges there between. Preferably, the weight ratio of ZnO to polyester resin is 0.05.

The pH of the polyester resin can be from 1 to 4, including 1.25, 1.5, 1.75, 2.0, 2.25, 2.5, 3.0, 3.25, 3.5, 3.75 and all values and subranges there between. Preferably the pH of the polyester is from 2.0 to 3.2. To comply with government regulations related to the transport of corrosive materials, the pH of the polyester resin can be increased by adding bases such as NaOH or NH₄OH. However, too much of the NaOH tends to decrease the tensile strength of the cured binder. Apparently sodium ions from the NaOH form monovalent carboxylate salts, which inhibit the formation of cross-linking coordination complexes involving carboxyl groups from different polymer molecules. In an alternative embodiment, zinc oxide powder or zinc oxide in water can be used to increase the pH of the polyester resin.

Compounds which can be used for mixing a cation with a resin or a binder made from this type of resin include metal oxides and hydroxides, such as zinc oxide and zinc hydroxide. Many metal oxides and hydroxides that are relatively insoluble in neutral water are amphoteric and will dissolve in either a strongly acidic or strongly basic aqueous medium. For example, ZnO will dissolve in a strongly acidic binder (ZnO+2H⁺→Zn²⁺+H₂O), and in a strongly basic binder (ZnO+2OH⁻+H₂O→Zn(OH)₄⁻). Thus, when added to a binder a compound such as ZnO can serve two purposes. First, if the binder is strongly acidic, then the compound can partially neutralize the binder to a pKₐ needed to form carboxylate anions. Second, the compound can provide a cation that can serve as an ionic bridging agent to cross-link and bond together different carboxylate anions.

The binder of the present invention may optionally contain conventional adjuncts or additives such as, for example, coupling agents, dyes, oils, fillers, thermal stabilizers, flame retarding agents, lubricants, and the like, in conventional amounts generally not exceeding 20% of the weight of the binder. For example, silane can be added to the binder to promote adhesion of the binder to fibrous insulation products. Emulsified oil can be added to the binder to suppress the generation of dust from fibrous glass insulation products. These various materials can be mixed with the polyester resin and cations to form the binder.

The binder can have a viscosity at 25° C. of from 1 to 20000 centipose, including 10, 20, 30, 40, 50, 60, 70, 80, 90, 500, 1000, 1500, 2000, 5000, 10000, 15000 and all values and subranges there between. In one embodiment, the binder can have a viscosity at 25° C. of from 1 to 100 centipoise.

The binder can be applied to or coated on fibers before or after the fibers are formed into a mat, batt or blanket. The fibers can be composed of conventional materials used for insulation as well as their mixtures such as, mineral wools, rock wools, and in one embodiment, the fibers can preferably be ceramic or glass fibers. Techniques for producing fibers are well known in the art and typically involve extruding molten material through small apertures. Techniques for applying binder to fibers and coating the fibers are also well known in the art, and include, for example, spraying the binder on the fibers. The fibers can be formed into non-woven or woven fibrous mats, batts and blankets by techniques that are well known in the art. The mats, batts or blankets of binder-coated fibers can be heated to evaporate water and other liquids from the binder and to cure the binder. The cured binder does not fill the interstitial spaces between fibers or translate fiber strength properties to the binder/fiber composite. Instead, the cured binder fixes the fibers together where the fibers cross, resulting in a porous insulation product. Although typically packaged in a compressed state, this porous insulation product will expand to close to its original dimensions when released from its packaging.

Heating cures the binder by causing the cations to form bonds with carboxylate anions on different polymer molecules to cross-link the binder. The binder can be cured at a temperature of from 150 to 240° C., including 160, 170, 180, 190, 200, 210, 220, 230, and all values and subranges there between. Preferably, the binder can be cured at a temperature of from 180 to 220° C. The binder can cure through the chelation of the carboxylate anions of the polymer and the cations. The cations are capable of bonding directly with two or more carboxylate anions (e.g., R—(C═O)—O-M-O—(C═O)—R′, where M is a cation, and R and R′ are on different polymer molecules). The cations and the carboxylate anions can form ionic, ion-dipole, or coordinate bonds. For example, each cation can form a coordination complex with two or more carboxylate anions. The cation will form the central atom of the coordination complex. Coordinate bonding may be intermediate between covalent and ionic (electrostatic) bonding.

Condensation reactions between the remaining carboxylic acid and hydroxyl groups in the binder system can occur depending on the reactions conditions (pH and temperature).

The insulation product described herein can be used to in any conventional manner that insulation products are used. For example, a building or portion of a building can be insulated in whole or in part by the installation of the insulation product. The product can be installed in a variety of locations, such as a wall, roof or floor, or in any construction scenario where building materials, such as insulation are commonly employed. For example, the insulation product can be used, in addition to buildings, in transportation or moving vehicles, such as automobiles, planes, and trains, and particularly those designed for refrigeration. In addition, appliances such as refrigerators and/or freezers may also benefit from the use of the insulation product described herein.

As used herein, “building” includes both commercial and residential buildings, such as office buildings, stores, houses and mobile homes. Thus, the insulation product bound with the polyester resin of the present invention can be employed during the construction of a new building or during the renovation of an existing building. The insulation would be provided to the appropriate location, e.g., between at least two studs of a wall or at least two rafters of a roof during the appropriate stage of the project. In a further embodiment, building components are commonly fabricated distant from the location of the actual location of the building (e.g., pre-fabricated building panels) and therefore, the insulation can be employed during the manufacturing of those pre-fabricated building components and include, for example, a pre-fabricated wall, roof, or floor component.

### EXAMPLES

The following non-limiting examples will further illustrate the invention.

### Example 1

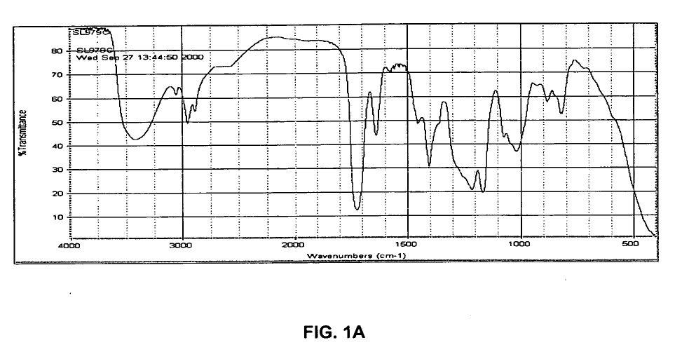

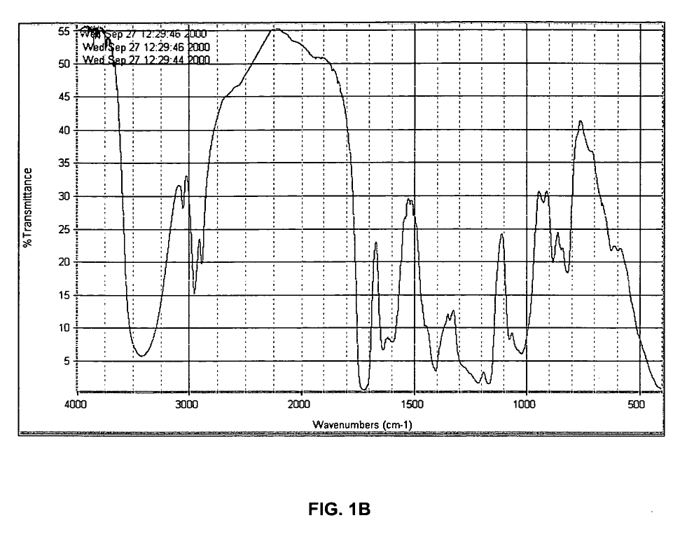

Propylene glycol (4 moles) was charged into a three liter flask and heated to 70-75° C. To the heated propylene glycol, maleic anhydride (3 moles), pentaerythritol (1 mole) and a few ml of concentrated sulfuric acid were added while maintaining the temperature at 65-70° C. The amount of propylene glycol was 15-16% in excess of the stoichiometric amount required for esterification. The propylene glycol/maleic anhydride mixture was held at 65-70° C. for 15 minutes. The mixture was then heated to 95-100° C. and held at this temperature for 1 hour. After the hold period, the acidity level was checked by titration with 0.1N NaOH until the acidity equaled 200-220 mg/g. The resulting mixture was then heated to 130° C. to promote esterification and distilled under vacuum to remove water and glycol. With the mixture at 130° C., the vacuum was then released. In order to determine the extent of the reaction, the acid value was checked and the mixture was held at 130° C. until the acid value was 50-60 mg/g, as carboxyl groups reacted to lengthen polyester chains. Excess distillate, based on the stoichiometric glycol amount, was added backed to the mixture. The mixture was cooled to 80° C. FIG. 1A is a Fourier Transform Infrared (FTIR) spectrum of a dry film made from the cooled mixture.

100 g of binder was formed by preparing a 10% polyester resin solution from the cooled mixture and then dissolving 0.5 g ZnO in 99.5 g of the 10% polyester resin solution. FIG. 1B is an FTIR spectrum of a dry film of the cured binder after addition of the zinc oxide. The split absorbance band that appears near 1600 cm⁻¹ after the addition of zinc oxide indicates that the zinc ion is coordinating with the free carboxyl groups of the polyester.

This binder was sprayed on a fibrous glass mat, and cured by heating the mat to approximately 220° C. for 5 minutes in a Mathis drying oven to form a mat using the inventive binder.

### Comparative Example 1

A conventional phenol-formaldehyde resin produced by Borden Chemical under the tradename DURITE IB-774 was made into a binder and was sprayed onto a fibrous glass mat comparable to that used to form the mat using the inventive binder. The phenolic binder was then cured by heating to 180° C. for 5 minutes, resulting in a mat which was representative of the conventional binder. The conventional phenolic control binder cured with a yellow color and exhibited very good wet and dry tensile properties.

### Example 2

### Tensile Strength Comparison

The tensile strength values of glass fiber mat specimens made in Example 1 and Comparative Example 1 were compared. Both mat specimens were tested in a similar manner. The substrate, a 0.22 mm thick sheet of Whatman GF/C paper, was impregnated with the binders in a controlled manner and the excess binder was removed using a vacuum table. The Example 1 specimens required a higher curing temperature than the Comparative Example 1 specimens using a conventional phenolic binder. A companion set of tensile specimens was exposed to moisture in an autoclave to assess the impact of humid aging on the binder. Both sets of test specimens were evaluated for their tensile strength properties using an Instron 4482 Tensile Tester in the tension mode. The maximum load required to rupture the 10 mm wide sample was recorded. The test results are shown in the following Table A.

TABLE A
Comparative Tensile Strengths of Binders

| | Comparative Example 1 | | Example 1 | |
|---|---|---|---|---|
| | Phenolic binder | | POLYESTER/ZnO BINDER | |
| | (Tensile strength - | | (Tensile strength - | |
| SAMPLE | Newtons) | | Newtons) | |
| NO. | DRY | WET | DRY | WET |
| 1 | 22.6 | 17.1 | 25.3 | 16.7 |
| 2 | 22.9 | 18.7 | 19.5 | 14.0 |
| 3 | 17.4 | 20.3 | 20.7 | 13.0 |
| 4 | 22.2 | 17.6 | 22.8 | 15.3 |
| 5 | 22.7 | 18.1 | 24.1 | 15.3 |
| 6 | 16.2 | 15.2 | 21.1 | 15.3 |
| Mean | 20.7 | 17.8 | 22.3 | 14.9 |
| Standard Dev. | 3.0 | 1.7 | 2.2 | 1.3 |
| Avg. wt % | 0.31 | 1.7 | 0.66 | 3.2 |
| moisture | | | | |
| Avg. wt % | 21.2 | 20.4 | 21.5 | 22.7 |
| binder | | | | |

Curing: Conventional binder - 180° C. for 5 minutes, Inventive binder - 220° C. for 5 minute

Table A shows that the binder of Example had statistically equivalent dry tensile strength relative to the phenolic binder of Comparative Example 1. Table A also shows that the binder of Example 1 had a tensile strength after humid aging about 84% that of the phenolic binder.

The Example 1 samples lost about 20% of their initial dry tensile strength after about 15 minutes of autoclaving and about 30% of their dry tensile strength after about 45 minutes of the autoclaving. In contrast, the phenolic binder samples of Comparative Example 1 lost about 30% of their initial dry tensile strength after the 15 minute autoclave test and about 40% of their dry tensile strength after 45 minutes of the autoclave test.

### Example 3

### Thickness Recovery

The thickness recovery of insulation batts produced using the polyester/ZnO binders was found to be about 90% of that of insulation batts made using the phenolic binder. Batts using the polyester/ZnO binders cured with a clean white appearance and had tensile strength values that approximated those of insulation batts made with the phenolic binder on the same insulation line.

### Example 4

### VOC Emissions

A pilot line trial of preparing insulation batts using binders as in Example 1 (Polyester/ZnO binder) and Comparative Example 1 (Phenolic binder) was performed. A comparison of the VOCs given off during curing of the polyester binder and of the phenolic binder in the pilot line trial is shown in the following Table B.

TABLE B
Measured emissions from conventional phenolic
and inventive polyester binders

| | | INVENTIVE POLYESTER/ |
|---|---|---|
| | PHENOLIC BINDER | ZnO BINDER |
| | (kg pollutant/ | (kg pollutant/ |
| POLLUTANT | metric ton glass) | metric ton glass) |
| Free phenol | 0.19 | 0.00 |
| Total phenol | 0.68 | 0.05 |
| Formaldehyde | 0.56 | 0.26 |
| Ammonia | 2.91 | 0.13 |
| Total organic | 5.11 | 7.20 |
| carbon (TOC) | | |
| Total nitrogen | 3.42 | 0.14 |
| Total organic | 1.03 | 0.10 |
| nitrogen | | |
| Propylene glycol | Not detected | 11.73 |
| Maleic acid | Not detected | 1.15 |

Table B shows that the polyester binder produces significantly less undesirable phenol and formaldehyde emissions than does the phenolic binder. Although the polyester binder emits propylene glycol, this compound is more environmentally benign than phenol and formaldehyde and can be recaptured and recycled.

The above results show that the polyester binders produce fibrous glass insulation products with tensile strengths comparable to fibrous glass insulation products produced using phenol-formaldehyde resins. The inventive binders also produce fibrous glass insulation product having a snow-white color, which provides a significant commercial advantage over the yellowish product produced by conventional phenol-formaldehyde binders.

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. A water-soluble composition, comprising
at least one polyester resin including molecules each containing at least two carboxyl groups; and
at least one cation of an element selected from the group consisting of Group IIA elements, transition metals, Group IIB elements, Group IIIA elements, Si, Ge, Sn, Pb, As, Sb, Bi, Te, and Po.

2. The water-soluble composition of claim 1, wherein the polyester resin is produced by a process comprising heating a mixture of at least one diol, and at least one member selected from the group consisting of carboxylic acids containing at least two carboxyl groups and anhydrides of carboxylic acids containing at least two carboxyl groups.

3. The water-soluble composition of claim 2, wherein the at least one diol comprises propylene glycol.

4. The water-soluble composition of claim 2, wherein the at least one member is an anhydride of carboxylic acid.

5. The water-soluble composition of claim 4, wherein the at least one member is a maleic anhydride.

6. The water-soluble composition of claim 2, wherein the heating is performed at a temperature of from 50 to 200° C.

7. The water-soluble composition of claim 2, wherein the mixture further comprises a mineral acid.

8. The water-soluble composition of claim 2, wherein after the mixture is heated, the process comprises neutralizing the mixture with a base.

9. The water soluble composition of claim 2, wherein after the mixture is heated, the process comprises neutralizing the mixture with zinc oxide.

10. The water-soluble composition of claim 1, wherein the at least one element is divalent.

11. The water-soluble composition of claim 1, wherein the at least one element is Zn.

12. The water-soluble composition of claim 1, further comprising pentaerythritol.

13. A method of making the water-soluble composition of claim 1, comprising
mixing at least one polyester resin including molecules each containing at least two carboxyl groups, and
at least one compound containing a cation of an element selected from the group consisting of Group IIA elements, transition metals, Group IIB elements, Group IIIA elements, Si, Ge, Sn, Pb, As, Sb, Bi, Te, and Po.

14. The method of claim 13, wherein the is an oxide or hydroxide of the at least one element.

15. The method of claim 13, wherein the polyester resin is produced by a process comprising heating a mixture of at least one diol, and at least one member selected from the group consisting of carboxylic acids containing at least two carboxyl groups and anhydrides of carboxylic acids containing at least two carboxyl groups.

16. The method of claim 15, wherein the at least one diol comprises propylene glycol.

17. The method of claim 15, wherein the at least one member is an anhydride of carboxylic acid.

18. The method of claim 17, wherein the at least one member is a maleic anhydride.

19. The method of claim 13, wherein the at least one element is divalent.

20. The method of claim 1, wherein the at least one element is Zn.

21. The method of claim 1, further comprising pentaerythritol.

22. A method of making an fibrous insulation product, comprising
coating fibers of the fibrous insulation product with the water-soluble composition of claim 1;
forming a porous mat, batt, or blanket comprising the coated fibers; and
heating said porous mat, batt, or blanket to cure the composition.

23. The method of claim 22, wherein the fibers comprise mineral wool.

24. The method of claim 22, wherein the fibers comprise glass.

25. The method of claim 22, wherein the cured composition comprises a chemical bond wherein at least one cation is directly bonded to two or more carboxylate anions.

26. The method of claim 25, wherein the two or more carboxylate anions are on different polyester molecules.

27. The method of claim 25, wherein at least one cation and two or more carboxylate anions form a coordination complex.

28. The method of claim 22, wherein the at least one cation is dissolved in water.

29. The method of claim 22, wherein the composition comprises at least one of zinc oxide and zinc hydroxide.

30. A fibrous insulation comprising a fibrous insulation component and a water-soluble binder, wherein the binder comprises at least one cation of an element selected from the group consisting of Group IIA elements, transition metals, Group IIB elements, Group IIIA elements, Si, Ge, Sn, Pb, As, Sb, Bi, Te, and Po and at least one polyester resin including molecules each containing at least two carboxyl groups, wherein the at least one cation is directly bonded to two or more carboxylate anions of the at least one polyester resin.

31. The fibrous insulation of claim 30, wherein the fibrous insulation component comprises mineral wool.

32. The fibrous insulation of claim 30, wherein the fibrous insulation component comprises glass.

33. The fibrous insulation of claim 30, wherein the two or more carboxylate anions are on different polyester molecules.

34. The fibrous insulation of claim 30, wherein the at least one cation and the two or more carboxylate anions form a coordination complex.

35. The fibrous insulation of claim 30, wherein the binder comprises at least one of zinc oxide and zinc hydroxide.

36. A method of constructing a building, comprising installing the fibrous insulation of claim 30 in said building.

37. A method of renovating a building, comprising installing the fibrous insulation of claim 30 to said building.

38. A building component, comprising the fibrous insulation of claim 30.

39. The building component of claim 38, which is selected from the group consisting of a roof, a wall, and a floor.

40. A building, comprising the fibrous insulation of claim 30.
